(19) United States
(12) Patent Application Publication
(10) Pub. No.: US 2015/0002088 A1
(43) Pub. Date: Jan. 1, 2015

(54) WIRELESS CHARGING DEVICE

(71) Applicant: Daniel Michael D'Agostino, Tucson, AZ (US)

(72) Inventor: Daniel Michael D'Agostino, Tucson, AZ (US)

(21) Appl. No.: 14/318,656

(22) Filed: Jun. 29, 2014

Related U.S. Application Data
(60) Provisional application No. 61/841,284, filed on Jun. 29, 2013.
(60) Provisional application No. 61/880,179, filed on Sep. 20, 2013.

(51) Int. Cl. H02J 7/02; H02J 7/00

(52) U.S. Cl. CPC H02J 7/025; H02J 7/0044; H02J 7/0052; H02J 2007/0096
USPC 320/108

(57) ABSTRACT

A wireless charging device comprising a base assembly having at least one first base terminal for input of electrical power and at least one second base terminal placed on a second base terminal housing of the base assembly for output of the electrical power and a head assembly detachably attached to the base assembly, the head assembly having at least one head terminal for input of the electrical power, at least one transmitter coil for transmitting the electrical power through inductive coupling to a receiver coil of a receiver mounted on at least one mobile device, the at least one mobile device detachably placed on a head cover of the head assembly, a magnet for facilitating attachment of the at least one mobile device to the head cover wherein the head assembly is attachable to a plurality of said base assemblies.

### CROSS-REFERENCE TO RELATED APPLICATIONS

This application claims the benefits of U.S. Provisional Application No. 61/841,284, filed Jun. 29, 2013, entitled WIRELESS CHARGER AND MOUNTING SYSTEM FOR MOBILE DEVICES and U.S. Provisional Application No. 61/880,179, filed Sep. 20, 2013, entitled WALL WIRELESS CHARGER FOR MOBILE DEVICES AND FURNITURE WIRELESS CHARGER FOR MOBILE DEVICES, the contents of which are incorporated herein by reference.

### FIELD OF THE INVENTION

The present invention generally relates to wireless technology. More particularly, the present invention relates to charging of mobile devices with a wireless charger.

### BACKGROUND OF THE INVENTION

Mobile devices like mobile phone, laptops, cameras and the like need regular charging of their batteries and it is a part of our daily lives. However, charging of the mobile devices through cables creates problems we all experience regularly. Mobile device users often settle by placing their charging cable throughout the house in a manner they would not allow for any other device. The cables don't really have a place where they belong. Instead, the cables rest on the floor, are stuffed between car seats, placed on our desks, and rest on nightstands. Additionally, people experience difficulty in connecting the charger cable in the correct orientation during the first attempt to plug it in or at night when the lights are off. Users often wake up reaching for their phone to see the time instead of simply looking at the time on their device without pressing any buttons or picking it up off the table. Users often experience problems associated with mounting a mobile device in a vehicle, home, or office. Users also find it awkward to hold the mobile device for several minutes in a single position while watching a video on their mobile device for the whole duration of the video.

Prior art wireless charger receivers, from all other manufacturers, used for the iPhone 4, iPhone 4s, iPhone 5 and future versions of the iPhone, may require a specific custom case. These cases are bulky and add additional bulk at the bottom, near the connector resulting in a longer case required to accommodate a standard connector. This occurs because all prior art devices such as Apple 30 Pin connectors, Apple Lightning connectors, and micro USB connectors are designed to extend beyond the connector port.

A prior art search revealed a number of patents and patent applications related to wireless charging but none have solved all of these problems. Instead, prior art wireless charging products position the mobile device flat or nearly flat with respect to the table it rests on and none currently include a vehicle mounted wireless charging system. Prior art wireless chargers are unable to provide solutions to existing problems associated with wireless charging systems. Prior art devices are not versatile enough to be used in the home or vehicle. Increased risk of accidents occur when users look down at their cup holder because they are using their mobile device to navigate and don't have a reliable mount to keep their eyes on the road while still looking at their GPS Navigation.

Consequently, there exists in the art a long felt need for a wireless charging device which provides multiple charging bases to allow the wireless charger to be moved from home, office, or vehicle without connecting or disconnecting any wire. There also exists in the art a long felt need for a wireless charging device which can hold a mobile device firmly to prevent it from slipping and falling off the mount of the wireless charger. There also exists in the art a long felt need for a wireless charging device which allows the mobile device to remain upright when attached to it. There also exists in the art a long felt need for a wireless charging device that has a detachable head for charging mobile devices. There also exists in the art a long felt need for a wireless charging device that has a Near Field Communication (NFC) tag in the wireless charging device to execute tasks automatically once connected to a mobile device which is NFC enabled. There also exists in the art a long felt need for a wireless charging device that embeds into the wall or furniture. There also exists in the art a long felt need for a wireless charging device that provides for a receiver assembly to be detachably attached to mobile devices. There also exists in the art a long felt need for a wireless charging device which provides an LED ring to illuminate the area at night and to locate the wireless charging surface. There also exists in the art a long felt need for a wireless charging device which provides the ability to allow firmware to be upgraded to the wireless charging device. Additionally, there also exists in the art a long felt need for a wireless charging device that provides a head assembly of the wireless charging device attachable to a speaker assembly for playing audio from a mobile device placed on the head assembly. Finally, there exists in the art a long felt need for a wireless charging device that accomplishes all the foregoing objectives and that is relatively inexpensive to manufacture, easy to use, has a self-contained design, a self-sealing design and solves all problems related to prior art systems.

### OBJECTS OF THE INVENTION

An object of the present invention is to provide a wireless charging device which provides the head assembly of the wireless charger to be detached from one base assembly, moved from home, office, or vehicle and attach the same head assembly to the same or different types of base assemblies.

Another object of the present invention is to provide a wireless charging device which grips a mobile device to prevent it from slipping and falling off the mount of the wireless charging device.

Yet another object of the present invention is to provide a wireless charging device which provides a head assembly with a magnet inside for firmly holding one or more mobile device when placed on the head assembly.

A still another object of the present invention is to provide a wireless charging device which provides maximum flexibility and allows the wireless charger part to remain upright.

A further object of the present invention is to provide a wireless charging device that provides a Near Field Communication (NFC) tag in the wireless charger to automatically execute tasks in the mobile device once an NFC enabled mobile device is connected to the wireless charger.

A still further object of the present invention is to provide a wireless charging device which provides an illuminating ring around the charging surface of the wireless charger.

A still another object of the present invention is to provide a wireless charging device that embeds into the wall and furniture.

A further object of the present invention is to provide a wireless charging device that provides the ability to allow firmware to be upgraded to the wireless charging device.

A still further object of the present invention is to provide a wireless charging device that provides a receiver assembly to be detachably attached to the mobile devices and that remain completely flush with the mobile device.

Yet another object of the present invention is to provide a wireless charging device that provides a detachable head assembly which is Bluetooth enabled.

Still another object of the present invention is to provide a wireless charging device that provides data transfer cables to connect the wireless charging device to an external device to carry electronic data files between the head assembly and the external device.

A further object of the present invention is to provide a wireless charging device that enables streaming of audio from a Bluetooth enabled mobile device to a Bluetooth less audio device without directly connecting the mobile device to the audio device through cables.

A still further object of the present invention is to provide a wireless charging device that provides attachment of the detachable head assembly to a speaker assembly for playing audio from a mobile device placed on the head assembly.

These as well as other objects of the present invention are apparent upon inspection of this specification, including the drawings and appendices attached hereto.

### BRIEF SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Accordingly, there is provided a wireless charging device which provides charging of mobile devices wirelessly without any cables. According to one embodiment of the present invention, a mobile device is mounted to the charging surface of the wireless charging device and mounting system by means of a high powered rare earth magnet or electromagnet is located behind the charging surface coupled with a special foam pad located on the charging surface which is designed to adhere to the attached mobile device. In accordance with one embodiment of the present invention, the receiver located on the mobile device includes a magnet in the center of the coil or magnetic material behind the coil. This yields an attractive force large enough to hold the mobile device in place along with the foam pad, which is designed to grip the surface of the mobile device by means of micro suction cups or other micro or macro mechanical or electrical means. The wireless charger and mounting system for mobile devices can be moved from a table at home or office to a vehicle quickly without using cables.

The wireless charging device of the present invention further comprises a Near Field Communication (NFC) tag that allows tasks such as an alarm clock, night clock, Bluetooth, Navigation/Maps, or a radio application to be launched on the mobile device simply by placing the mobile device to the wireless charger. In accordance with one embodiment of the present invention, the gooseneck of the wireless charger allows the wireless charger and mounting system for mobile devices to be flexible and angled allowing the mobile device to face a user at any angle instead of being required to lay flat or near flat while charging wirelessly. The indicator LED is illuminated by means of a proximity switch, capacitance switch, or other mechanical or electrical switch technology. This allows the user to illuminate the area under low light conditions. Receiver modules are designed to be thin and small. The custom connectors are designed to be low profile such that they do not protrude beyond the body of the device when connected. The thin flexible or rigid receiver is electrically connected to the connector such that the receiver module is flush with the mobile device when connected. The receiver module wraps around the back of the mobile device where it attaches to the mobile device or mobile device case. This allows for any mobile device case to be used without restrictions due to the connector protruding beyond the surface of the mobile device when connected.

This Wall and Furniture Wireless Chargers charge mobile devices wirelessly without any cables, unlike wired chargers. A mobile device is mounted to the charging surface by means of a high powered rare earth magnet or electromagnet located behind the charging surface coupled with a micro suction foam pad, foam pad, rubber pad, rubberized paint, textured surface, no surface finish, or any other surface finish designed to hold the mobile device to the wireless charging device. The receiver located on the mobile device includes a magnet in the center of the coil or magnetic material behind the coil. This yields an attractive force large enough to hold the device in place along with the foam pad, which is designed to grip the surface of the mobile device by means of micro suction cups or other micro or macro mechanical or electrical means. The mobile device can quickly be placed on a wall or furniture wireless charger without using cables.

The head assembly of the wireless charging device of the present invention is also attachable to a speaker assembly built to accommodate the head assembly for playing audio from a Bluetooth enabled mobile device.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 shows a side view of wireless charging device in accordance with one embodiment of the present invention;

FIG. 2 illustrates a front view of the assembled wireless charging device in accordance with one embodiment of the present invention;

FIG. 3A illustrates an isometric view of the base assembly of the wireless charging device in accordance with one embodiment of the present invention;

FIG. 3B illustrates an isometric view of the head assembly of the wireless charging device in accordance with one embodiment of the present invention;

FIG. 4 shows an exploded view of the head assembly in accordance with one embodiment of the present invention;

FIG. 5 shows a mobile device with receiver and back cover in accordance with one embodiment of the present invention;

FIG. 6 shows illustrates a mobile device placed on a wireless charging device in accordance with one embodiment of the present invention;

FIG. 7 shows an exploded view of a wireless charging device suitable for use in vehicle in accordance with one embodiment of the present invention;

FIG. 8 illustrates a wireless charging device mounted in wind shield of a vehicle, in accordance with one embodiment of the present invention;

FIG. 9 illustrates an exploded view of a surface mounted wireless charging device in accordance with one embodiment of the present invention;

FIG. 10 illustrates a surface mounted wireless charging device being installed on a surface in accordance with one embodiment of the present invention;

FIG. 11 shows a side view of installed surface mounted wireless charging device accordance with one embodiment of the present invention;

FIG. 12 shows a perspective view of installed surface mounted wireless charging device accordance with one embodiment of the present invention;

FIG. 13 shows a perspective view of installed surface mounted wireless charging device with a mobile device placed on it in accordance with one embodiment of the present invention;

FIG. 14 shows a side view of a speaker assembly to which head assembly of the wireless charging device can be attached in accordance with one embodiment of the present invention;

FIG. 15 shows a rear view of a speaker assembly to which head assembly of the wireless charging device can be attached in accordance with one embodiment of the present invention;

FIG. 16 shows a side view of a speaker assembly with head assembly of the wireless charging device attached in accordance with one embodiment of the present invention;

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the present invention are described herein in the context of a wireless charger and mounting system for mobile devices. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

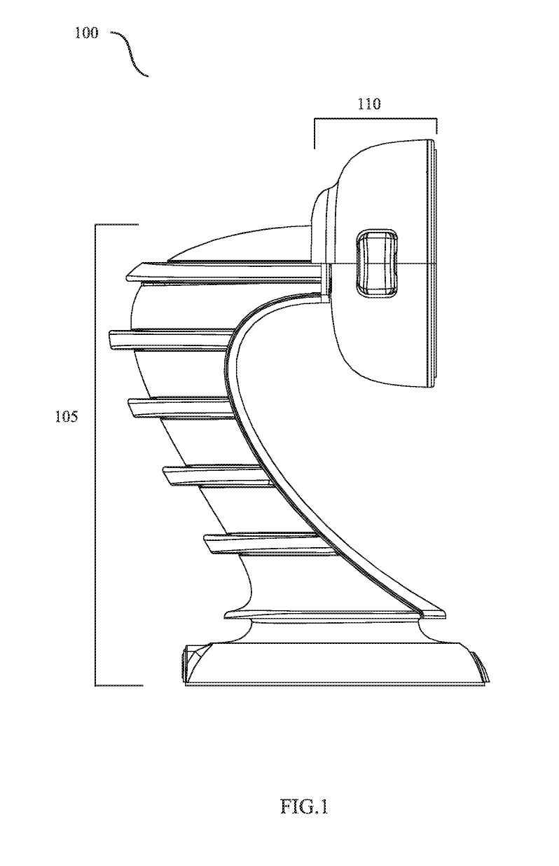

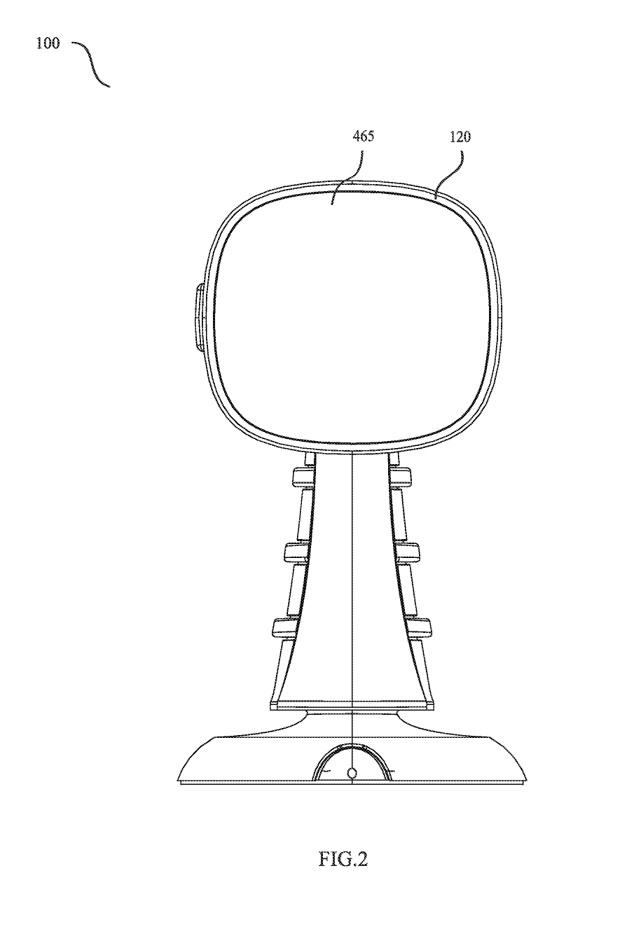

FIG. 1 shows front view and FIG. 2 shows side view of the wireless charging device 100 in accordance with one preferred embodiment of the present invention. This embodiment of the present invention is particularly suitable for use at home, work place etc. and also in vehicle. In this embodiment of the present invention, as shown in FIG. 1, the wireless charging device 100 comprises of two distinct parts, the base assembly 105 and the head assembly 110.

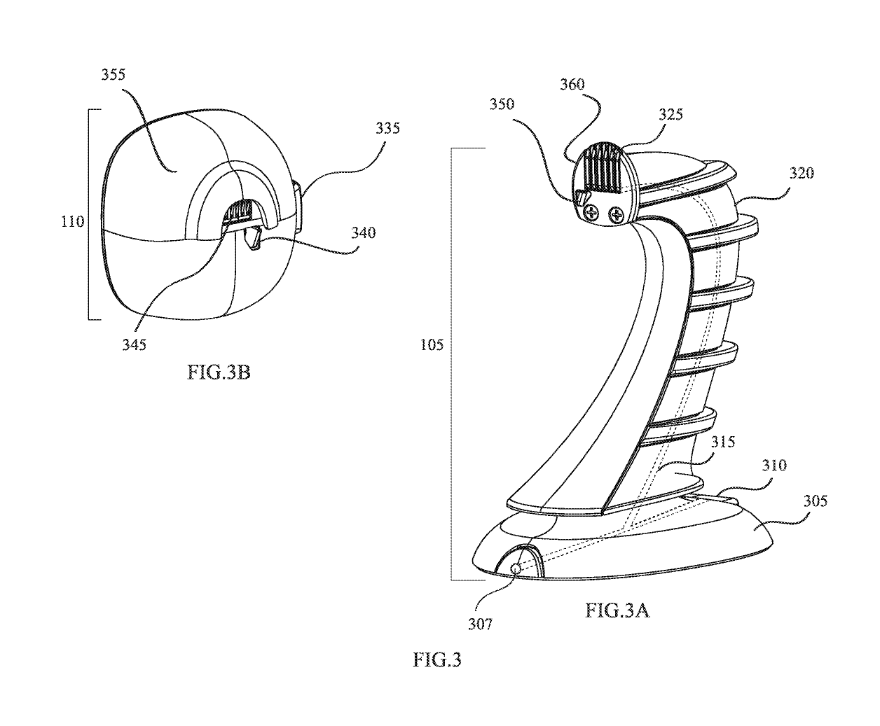

As best illustrated in FIG. 3A, the base assembly 105 has a base 305 to which an extended arm 320 is securely positioned. On the back of the base 305 there is a first base terminal 310 for receiving electrical power from the mains (not shown in the figure) and for transmitting data signals to an data player (not shown in the figure). The base first base terminal 310 has standard connectors for receiving electrical power and for transmitting data signals. At the other end of the extended arm 320 a second base terminal 325 is placed on the second terminal housing 360. The electrical power and the data signal run through the cable harness 315 (shown in dotted lines) between first base terminal 310 and second base terminal 325. There is a first Light Emitting Diode (LED) 307 positioned at the front of the base 305 to which power is supplied from the cable harness 315. There can be plurality of cables according to the need in the wire harness 315.

FIG. 3B illustrates a rear side perspective view of the head assembly 110 of the wireless charging device 100 of the present invention. The head assembly 110 has a head terminal 330 for receiving electrical power and transmitting data signal. The rear side profile of the housing 355 of the head assembly 110 is such that the head assembly 110 can easily be aligned and mounted to second base terminal housing 360 of the base assembly 105. The second base terminal 325 of the base assembly 105 is compatible with head terminal 345. There is a locking mechanism 340 in the head assembly 110 which is a part of the locking button 335. When the head assembly 110 is placed fully down over the second base terminal housing 360, the locking mechanism 340 gets locked with the slot 350 provided in the second base terminal housing 360. With a small push of the locking button 335 the locking mechanism 340 comes out of the slot 350 and the head assembly 110 can be easily detached from the base assembly 105.

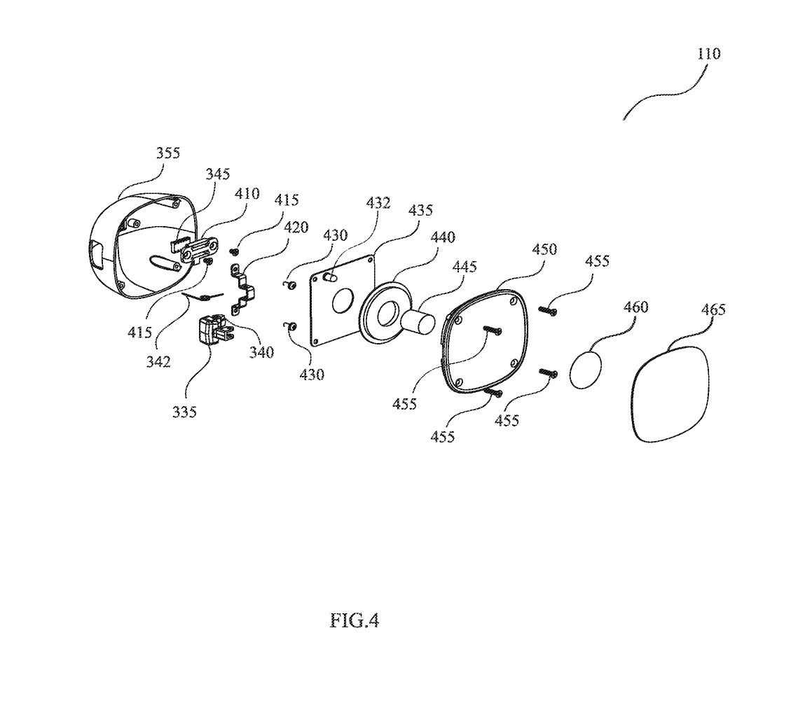

FIG. 4 illustrates an exploded view of the head assembly 110 in accordance with an embodiment of the present invention. The input terminal 345 is mounted to connector housing 410 which in turn is mounted to the head housing 355 with fasteners 415. The locking button 335 is mounted to a bracket 420. A torsional spring 342 is placed between the locking button 335 and the bracket 420. A spring pin (not shown in the figure) connects the locking button 335 to the bracket 420. The spring pin goes through the torsional spring 342 as well as the bracket 420 and locking button 335. This allows the locking button 335 to rotate about the spring pin. The bracket 420 is mounted to head housing 355 with the help of fasteners 430. The locking button 335 includes a locking mechanism 340 to lock the head assembly 110 to base assembly 105 (shown in FIG. 3A). The head cover 450 is mounted to the head housing 355 with the help of fasteners 455. A magnet 445 is mounted directly to the head cover 450. In a preferred embodiment of the present invention the magnet 445 used is a rare earth magnet neodymium. However, an electromagnet can also be used for the same purpose. A transmitter coil 440 is mounted to the head cover 450. Preferably, there is approximately a 5 inch of wire (not shown in the figure) connected between the Printed Circuit Board (PCB) 435 and the transmitter Coil 440 to allow the transmitter coil 440 to freely move and be connected to the head cover 450. The PCB 435 gets electrical power from the head input receiver through flexible wires (not shown in the figure). In a preferred embodiment, the head cover 450 is made from clear Polycarbonate or Acrylic or any other clear plastic type material. The surfaces of the head cover 450 are smooth with the exception of the outer edges on the side facing outwards. This surface is textured to diffuse light. Inside the head assembly 110, on the PCB 435 there is a light source, preferably a Light Emitting Diodes (LED)(s) 432 installed, which creates light that transmits through the head cover 450 and diffuses out of its textured surface. The light creates a ring 120 shown in FIG. 1 around the gripping surface 465 which helps to locate the wireless charging device 100 at night. In a preferred embodiment of the present invention, the gripping surface 465 is made from a foam pad, micro suction foam pad, rubber pad or rubberized paint and/or it may be a textured surface or any other surface finish designed to offer good gripping action when an object is attached to it. A Near Field Communication (NFC) Tag 460 is placed between the gripping surface 465 and head cover 450 which is a device that can communicate to an NFC enabled device through radio communication when placed close to the NFC tag.

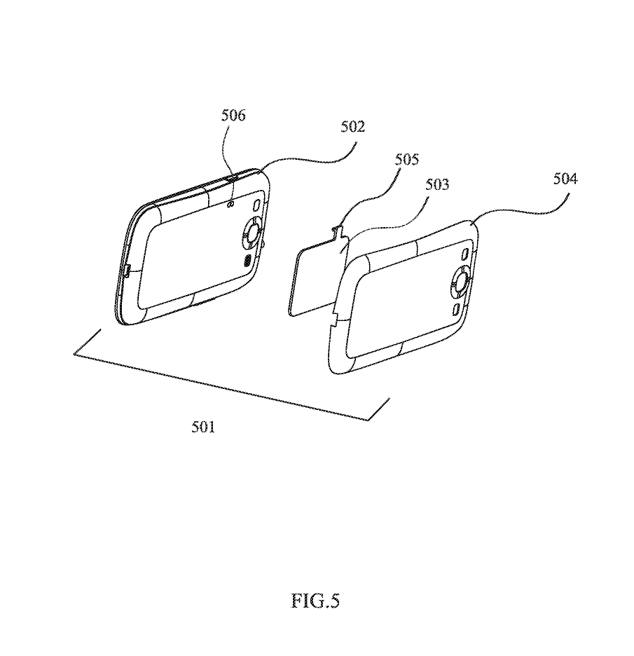

The mobile device described herein refers to mobile phone, smartphone, mobile watch, wireless headset, wireless headphones, a tablet, a laptop, ultrabook or any other mobile device which has a rechargeable battery. FIG. 5 illustrates a mobile device i.e. smartphone 502, a receiver 503 and a cover 504. Together these three components (502 to 503) is being referred as a wireless chargeable mobile device 501. The receiver 503 includes a receiver coil (not shown in figure). The receiver 503 transmits received power to battery (not shown in figure) of smartphone 502 through terminal 505 of receiver 503 and terminal 506 of smartphone. The receiver coil of the receiver 503 can be mounted on a ferrite sheet and the receiver may also include a small magnet.

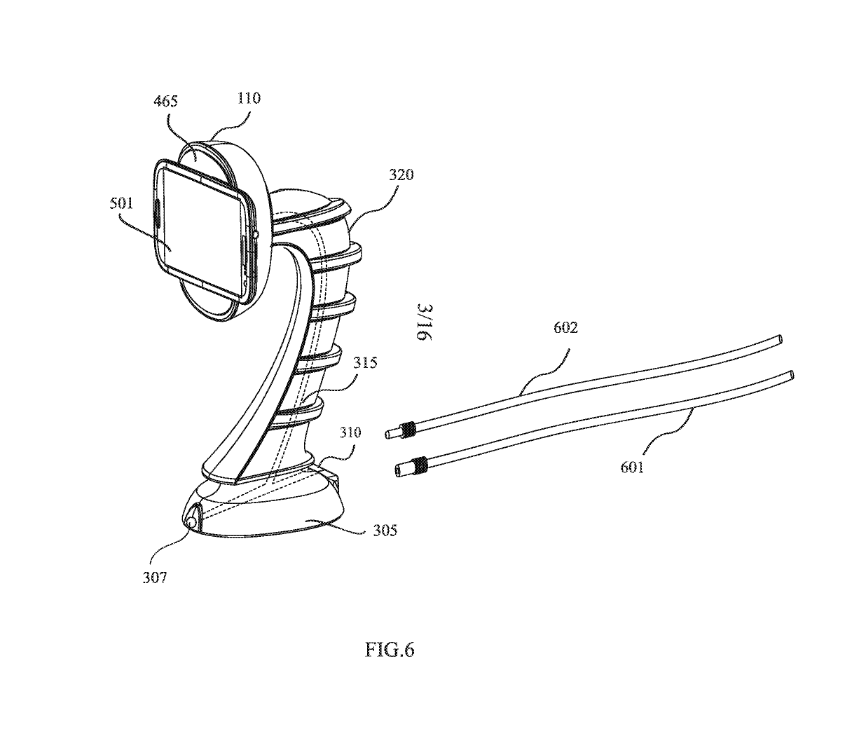

The design of the base assembly 105, according to one embodiment of the present invention, as shown in FIG. 1, FIG. 2, FIG. 3A, FIG. 3B, FIG. 4, FIG. 5 and FIG. 6, is such that the head cover surface or the gripping surface 465 of the head assembly 110 remains in a vertical position to the surface of the base 305 when the head assembly 110 is attached to the second base terminal housing 360 of the base assembly 105. Accordingly, when a wireless chargeable mobile device 501 is placed on the gripping surface 465, due to magnetic force of attraction between the magnet 445 and receiver 503 which may include a magnet and a ferrite sheet, and also due to the mechanical gripping action of the gripping surface 465, the wireless chargeable mobile device 501 remains firmly in an upright position. For a person, who would like to watch a video on the smartphone or would like to use his smartphone as a watch, when at home or when sleeping, it is convenient when the smartphone is held upright.

Reference to FIG. 1 through FIG. 6, in a preferred embodiment of the present invention, the wireless charging device receives electrical power from cable 601 and data signal cable 602 through first base terminal 310. The electrical power then transmit through cable harness 315 to second base terminal 325 from where it transmit to head terminal 345 of the head assembly 110. From input terminal 345 the electrical power then transmits to Printed Circuit Board 435 through wires (not shown in figures). The LEDs (not shown in figure) on Printed Circuit Board 435 get the electrical power and glow which makes the frontal peripheral area 120 (FIG. 2) of head assembly 110 glow dimly. The transmitter coil 440 also receives power from the Printed Circuit Board 435 and, through inductive coupling, the power transmits to the receiver coil of the receiver 503 which is additionally installed or inbuilt in mobile device 502. The electrical power then transmits to the rechargeable battery of the mobile device 501 through terminal 505 of receiver 503 and terminal 506 of mobile device 501 and the charging begins. LED 307 placed at the base of the wireless charging device 100 also glows by getting power through the cable harness 315.

In some preferred embodiment of the present invention the head assembly 110 also includes one or more Bluetooth module (not shown in the figures). The Bluetooth module of the head assembly 110 can establish radio communication with any Bluetooth module that may be present in the mobile device 501 being placed on the head assembly 110. Through the radio communication established between the said Bluetooth modules of head assembly 110 and mobile device 501, electronic data files, in the form of audio, video or any other such transferable files, can be transferred from the mobile device 501 to head assembly 110. The received electronic data file then can be transmitted via cable harness 315 and data cable 602 to any additional suitable device for storage or execution. For example, music can be streamed from a mobile phone, through Bluetooth or radio communication, established between a mobile phone placed on the head assembly of the wireless charging device of the present invention and the head assembly, to an audio player connected to the other end of the data cable 602. Thus, the wireless charging device of the present invention, in some its embodiments, enables data transfer from a device, like a mobile phone or any other device having Bluetooth like facility, to a device like an audio or video player even if the audio or video player do not have Bluetooth like facility.

Reference to FIG. 4, FIG. 5 and FIG. 6, the wireless charging device of the present invention also offers additional facilities to the user if the mobile device attached to the wireless charging device is NFC enabled. If the mobile device 501 is NFC enabled, then as soon as the mobile device is attached to the gripping surface 465 of the head assembly 110 for charging, radio communication is established between the NFC tag 460 and the NFC enabled mobile device 501. Through radio communication established, the NFC tag 460 executes various tasks automatically in the mobile device 501 provided compatible applications are present in the mobile device 501. Such automatic tasks may include activation of alarm clock, activation of watch, activation of navigation map etc. in the mobile device 501 as per user setting. In an example, when a user visits a restaurant and places his/her NFC enabled mobile phone on the wireless charging device of the present invention installed at the restaurant for customers for charging, the NFC tag installed in the wireless charging device would communicate with the mobile phone to automatically or with user's permission launch one or more applications, like a page of social media network belonging to the restaurant in the mobile phone to advertise the restaurant's profile, The embodiment of the wireless charging device of the present invention illustrated from FIG. 1 through FIG. 6 can be preferably used at places like home, office etc.

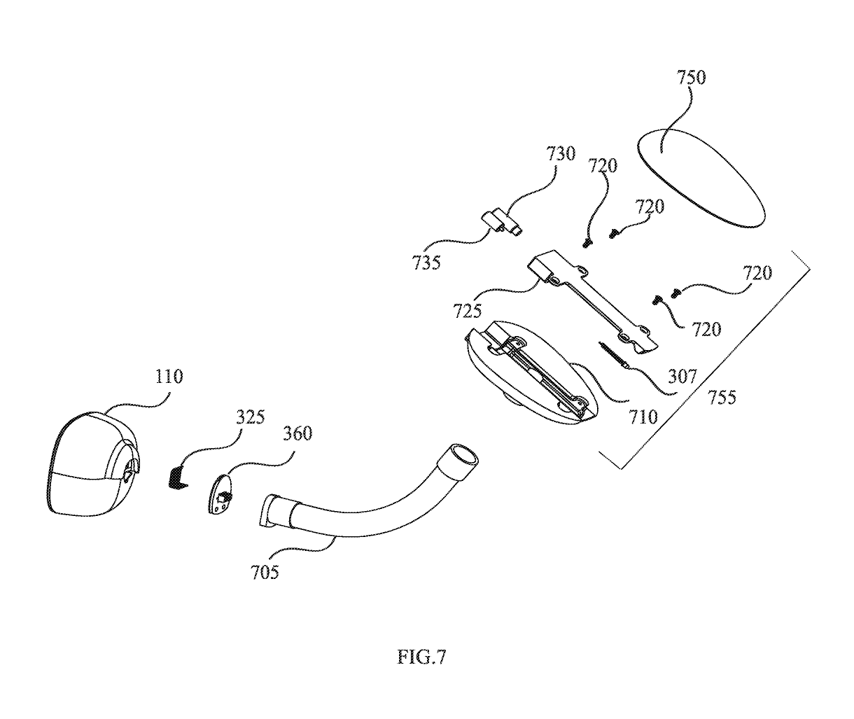

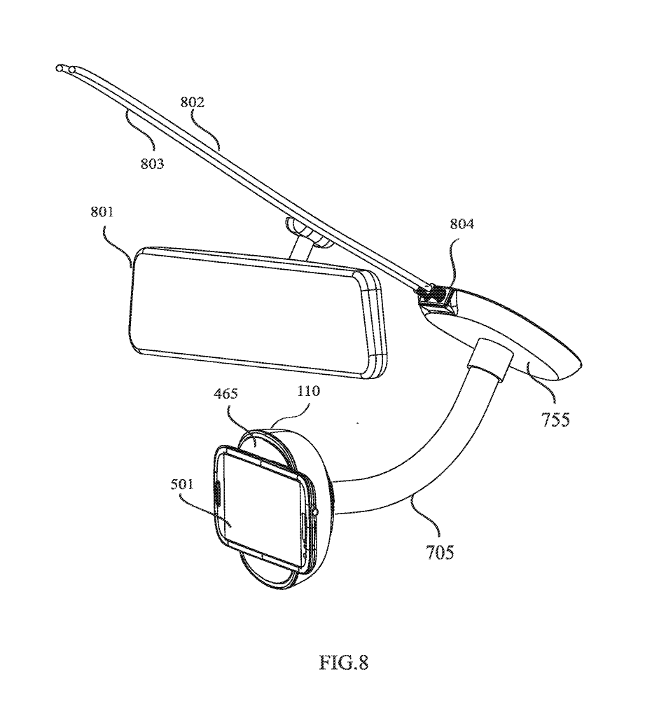

FIG. 7 illustrates another preferred embodiment of the wireless charging device of the present invention. The dimensions of the second base terminal housing 360 and the second base terminal 325 remains same as that of the above described embodiment of the invention illustrated in FIG. 1 through FIG. 6. As a result, the same head assembly 110 can similarly be attached to and removed from the second base terminal housing 360. This makes it possible to use the same head assembly, which is the most expensive component of the wireless charging device of the present invention, interchangeably between base assembly of the embodiment shown in FIG. 1 through FIG. 6, and base assembly shown in FIG. 7 and FIG. 8. The base assembly shown in FIG. 7 and FIG. 8 is suitable for use in vehicle. In this embodiment of the present invention, the extended arm 705 has dimensions different from that of extended arm 320 shown in FIG. 3A. The components and their dimensions of the base 755 of this embodiment of the present invention shown in FIG. 7 are essentially the same as those (not shown in figure) of the base 305 shown in FIG. 1 through FIG. 6 in one of the other embodiments of the present invention. Component 725 is a strain relief with a lens which is fixed to base 710 with the help of fasteners 720. The strain relief 725 helps distribute and relief the strain that may be generated due to connection of power cable 802 and data cable 803 (shown in FIG. 8) to the power connector 730 and data connector 735 which form the first base terminal 804 (shown in FIG. 8). An LED (307) is molded or mounted to the front side of strain relief 725.

According one preferred embodiment of the present invention, as illustrated in FIG. 8, the wireless charger of the present invention can be installed at the windshield (not shown in figure) of a vehicle from inside near mirror 801. The pad 750 located at the bottom of the base 755 helps to fix the wireless charging device of the present invention on the windshield or on any other surface also protecting the surface of installation from scratches. A mobile device 501 can then placed on the gripping surface 465 of charger head assembly 110 for charging. In a preferred embodiment, the NFC tag 460 present in the head assembly 110 activates an application, for example a navigation map, in the mobile device 501 through radio communication as soon as the NFC enabled mobile device, say for example a smartphone, is placed on the gripping surface 465. The design of this embodiment of the present invention enables the driver of the vehicle (not shown in figure), in which the wireless charger device is installed, to look at the display of the mobile device 501 without requiring looking away from the road ahead while driving. The magnetic force of attraction between the magnet 445 of the head assembly 110 and receiver magnet or receiver ferrite sheet (both not shown in figures) of receiver 503 along with the gripping action of the gripping surface 465 ensures that the mobile device 501 is firmly held to the wireless charging device of the present invention.

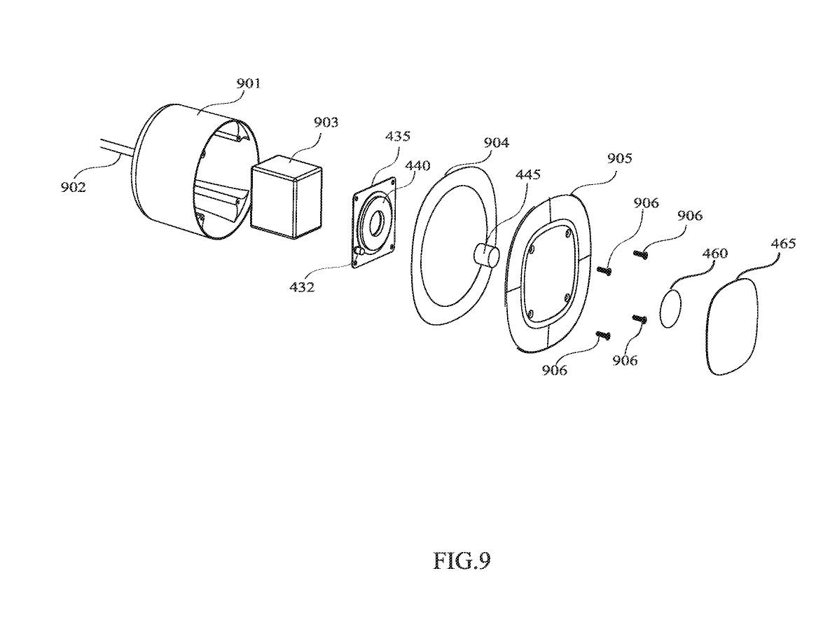

FIG. 9 illustrates an exploded view of another embodiment of the wireless charging device of the present invention which is particularly suitable for installation on a surface like a furniture surface or a wall surface. This embodiment of the present invention is being referred to as a surface mounted wireless charging device hereinafter. As shown in FIG. 9, in a preferred embodiment, the surface mounted wireless charging device of the present invention comprises of two main components, a housing 901 and a head cover 905. The housing 901 includes, but not limited to, an AC power to DC power converter 903 which receives electrical power from the mains through power cable 902 and converts AC power to DC power, a Printed Circuit Board (PCB) 435 which is connected to the AC-DC converter 903 through wire (not shown in figure), a light source 432, which can be a Light Emitting Diode (LED) which gets power from the PCB 432, a transmitter coil 440 also getting power from the PCB 432, an adhesive tape 904 pasted to the inside periphery of the head cover 905, a magnet 445 mounted to the inside of the head cover 905. A head cover 905, which is preferably made from clear Polycarbonate or Acrylic or any other clear plastic type material, is fixed over the housing 901 with the help of fasteners 906. The surface of the head cover 905 is preferably smooth with the exception of the outer edges on the side facing outwards. This surface is textured to diffuse light. As the LED 432 glows, the light transmits through the head cover 905 and diffuses out of its textured surface. In a preferred embodiment of the present invention, a gripping surface 465, is attached to the head cover 905. The gripping surface 465 is preferably made from foam pad, micro suction foam pad, rubber pad or rubberized paint and/or it may be a textured surface or any other surface finish designed to offer good gripping action when an object is attached to it. A Near Field Communication (NFC) Tag 460 is placed between the gripping surface 465 and head cover 905 which is a device that can communicate to an NFC enabled device through radio communication when placed close to the NFC tag. As discussed above, the surface mounted wireless charging device essentially comprises of the same components as that of the other embodiment of the present invention illustrated through FIG. 1 to FIG. 8 with the exception of the AC-DC converter 903 which is present only in the embodiment surface mounted wireless charging device of the present invention.

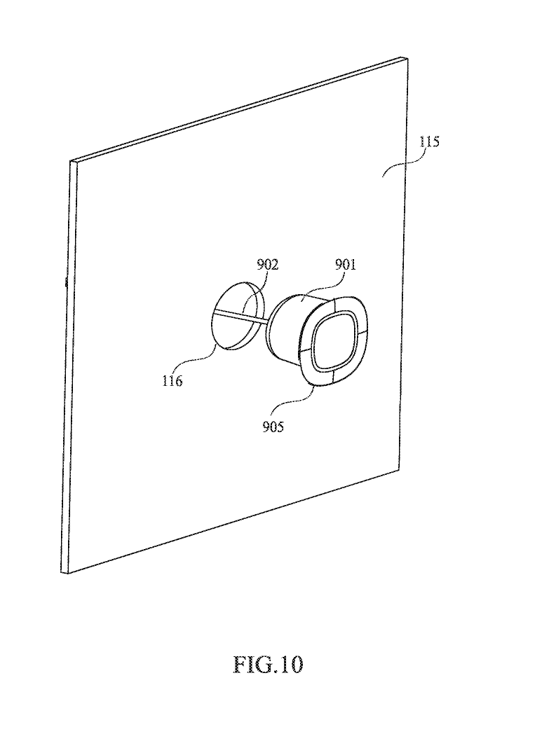

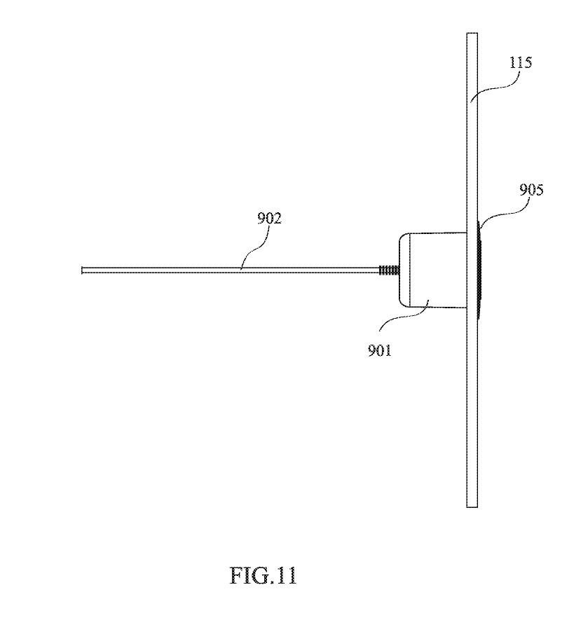

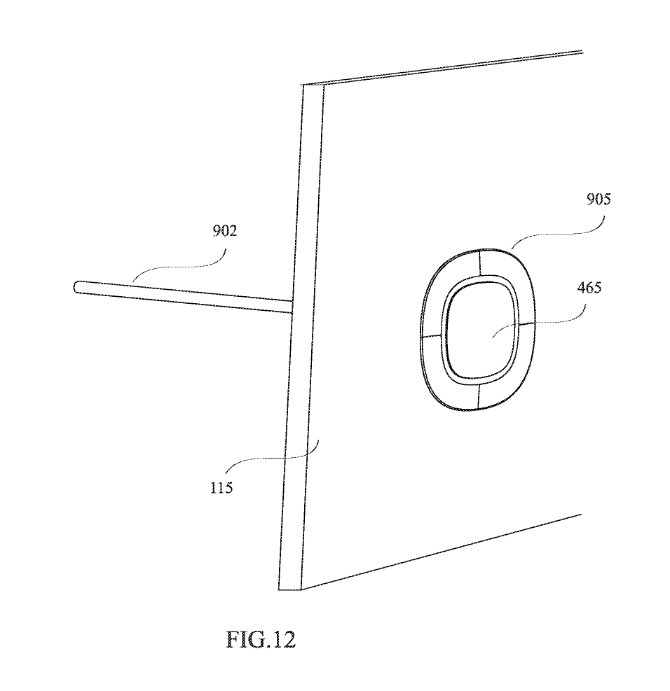

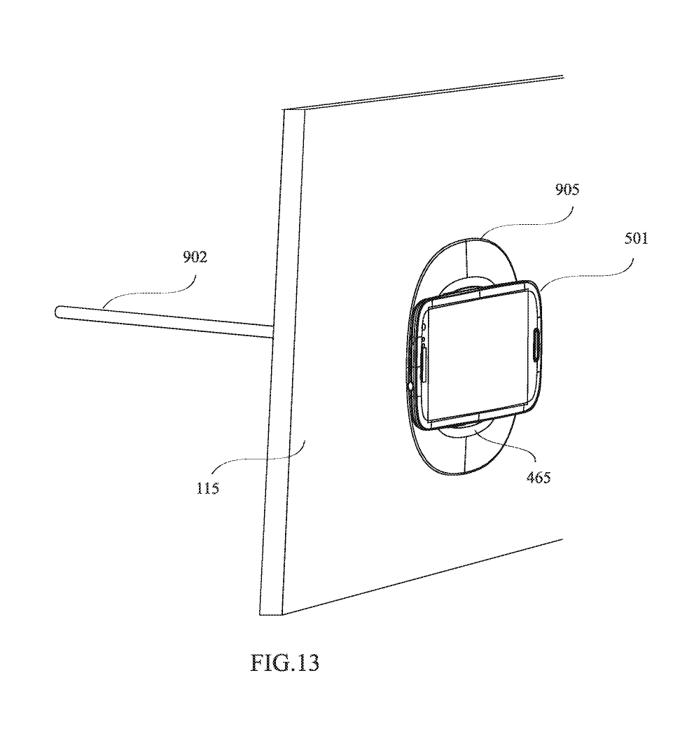

FIG. 10 illustrates the surface mounted wireless charging device of the present invention being installed on a surface in accordance with one embodiment of the present invention. For installation on a surface of a table or on surface of a wall, a hole 116 is to be cut through the surface 115 of the table or wall to accommodate the housing 901 of the surface mounted wireless charging device. The power cable 902 can be suitably laid upto an electrical power source (not shown in figure). Once the release liner of the adhesive tape 904 is peeled off and the surface mounted wireless charger of the present invention is fully inserted into the hole, the surface mounted wireless charger sits firmly on the surface 115 as shown in FIGS. 11 and 12. The low profile design of the head cover 905 ensures that the head cover 905 remains slightly projected from the surface 115 to which it is installed. FIG. 13 shows a mobile device 501 being placed to the gripping surface 465 of the head cover 905. The functioning and purpose of the components, such as the functions of the magnet 445, NFC tag 460 and gripping surface 465, among others, are same as those of the wireless charging device illustrated through FIG. 1 to FIG. 7. Accordingly, the surface mounted wireless charging device of the present invention offers the same facilities to the users, in addition to wireless charging of mobile device, as those offered by the wireless charging device illustrated through FIG. 1 to FIG. 7 except the fact that there is no detachable head assembly in case of surface mounted wireless charger.

In a preferred embodiment of the present invention, the housing 901 of the surface mounted wireless charging device is made in cylindrical shape. This cylindrical shape of the housing 901 makes its installation onto a surface easier. A hole saw bit, capable of making a hole on a surface with a shape and size suitable for installation of the housing 901, can also be provided for easier installation of the surface mounted wireless charging device.

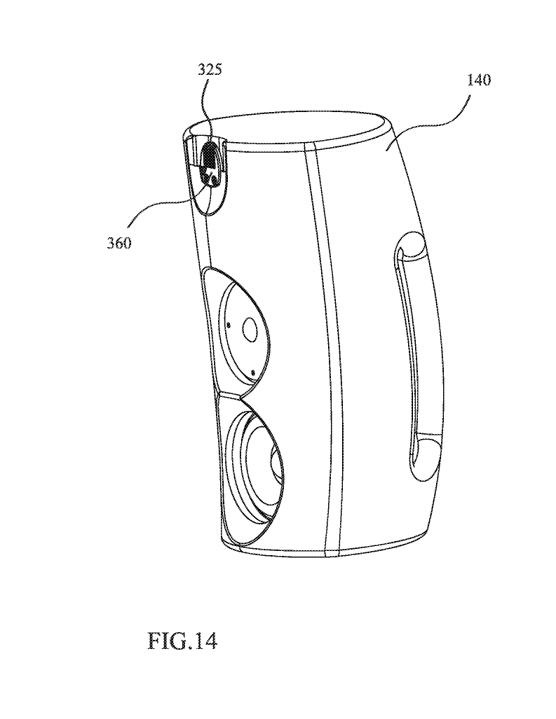

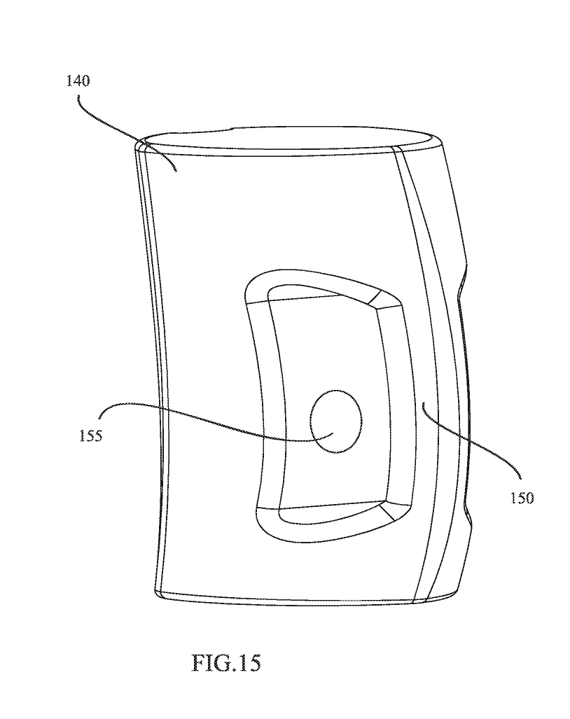

In accordance with another embodiment of the present invention, a speaker assembly 140, as shown in FIG. 14, is built with an arrangement to enable attachment of the head assembly 110 of the wireless charging device to the speaker assembly 140. The housing of the speaker assembly 140 has the same terminal 325 and same terminal housing 360 as in the other embodiments of the present invention described above so that the same head assembly 110 described so far can be attached to the speaker assembly 140. FIG. 15 shows the rear side of the speaker assembly 140 with its handle 150. In a preferred embodiment of the present invention, speaker port 155 is located under the handle 150.

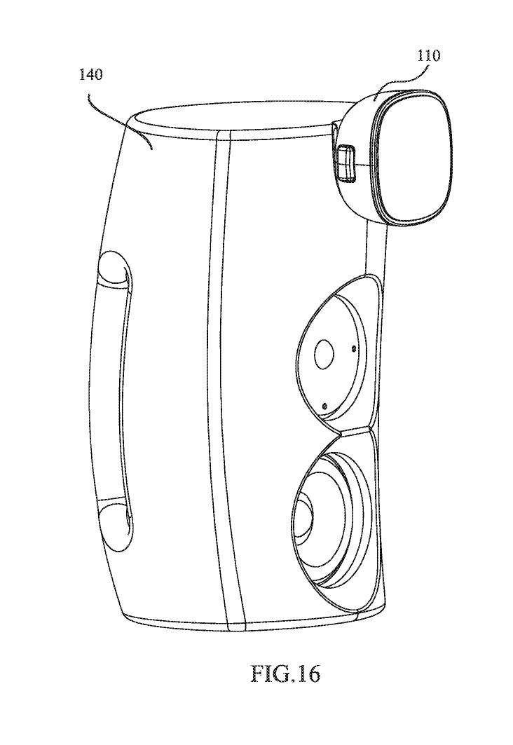

FIG. 16 shows the head assembly 110 of the wireless charging device attached to the speaker assembly 140. When a Bluetooth enabled mobile device is placed on the head assembly 110, the speaker assembly 140 can play music from the mobile device.

In a preferred embodiment, firmware installed in the head assembly 110 to execute one or more task can be downloaded from a mobile device attached to the head assembly 110 of the wireless charging device of the present invention.

Although particular extended arm designs of the wireless charging devices are shown and described herein, it would be obvious to those skilled in the art that the same functionalities can be obtained by manufacturing the extended arm different designs also. In some embodiments of the present invention the extended arm can be a part of the detachable head assembly instead of being a part of the base assembly and, in those embodiments, the head assembly including the extended arm becomes detachable from the base assembly for use in multiple bases.

The input/output terminals can have any suitable configuration. Also, the wireless charging device can be made according to the wireless charging standards such as Qi standards.

Although only one mobile device is shown placed on the wireless charging device of the present invention in the figures, it is to be understood that the wireless charging device can be made to accommodate multiple mobile devices for charging.

Additionally, other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A wireless charging device, the device comprising:
a base assembly having at least one first base terminal for input of electrical power and at least one second base terminal placed on a second base terminal housing of said base assembly for output of said electrical power; and
a head assembly detachably attached to said base assembly, said head assembly having at least one head terminal for input of said electrical power, at least one transmitter coil for transmitting said electrical power through inductive coupling to a receiver coil of a receiver mounted on at least one mobile device, said at least one mobile device detachably placed on a head cover of said head assembly, a magnet for facilitating attachment of said at least one mobile device to said head cover;
wherein said head assembly is attachable to a plurality of said base assemblies.

2. The wireless charging device as in claim 1, wherein said plurality of base assemblies are made in different dimensions keeping dimensions of said second base terminal and second base terminal housing same enabling attachment and removal of said head assembly into plurality of said base assemblies of different dimensions.

3. The wireless charging device as in claim 1, wherein said device further comprising at least one Near Field Communication tag in said head assembly for establishing radio communication with Near Field Communication enabled said at least one mobile device detachably placed on said head assembly.

4. The wireless charging device as in claim 3, wherein said Near Field Communication enabled at least one mobile device executes at least one task based on said radio communication from said Near Field Communication tag.

5. The wireless charging device as in claim 4, wherein said at least one task executed by said mobile device is activation of an alarm, a night clock, a map, a Navigation, a Bluetooth, a radio application and social media check in application.

6. The wireless charging device as in claim 1, wherein said receiver includes a magnet.

7. The wireless charging device as in claim 1, wherein said receiver includes a ferrite sheet.

8. The wireless charging device as in claim 1, wherein said magnet facilitates holding of said at least one mobile device by said head cover of said head assembly due to magnetic force of attraction between said magnet of head assembly and said receiver.

9. The wireless charging device as in claim 1, wherein said base assembly includes a base and an extended arm to which said head assembly is attached.

10. The wireless charging device as in claim 1, wherein said head assembly includes a head and an extended arm which is attached to said base assembly.

11. The wireless charging device as in claim 1, wherein said head assembly is attachable to a speaker assembly to play audio.

12. The wireless charging device as in claim 1, wherein connector of said receiver remains flush with said mobile device surface.

13. The wireless charging device as in claim 1, wherein said head assembly includes at least one light source which glows through said head cover.

14. The wireless charging device as in claim 1, wherein said wireless charger and said receiver are inductive power transfer standard compliant.

15. The wireless charging device as in claim 1, wherein said head cover includes a gripping surface to hold said at least one mobile device.

16. The wireless charging device as in claim 15, wherein said gripping surface includes a foam pad to hold said at least one mobile device.

17. A wireless charging device, the device comprising;
a base assembly having at least one first base terminal for input of electrical power and output of at least one electronic data file and at least one second base terminal placed on a second base terminal housing of said base assembly for output of said electrical power and input of at least one said electronic data files; and
a head assembly detachably attached to said base assembly, said head assembly having at least one head terminal for input of said electrical power and output of said at least one electronic data files, at least one transmitter coil for transmitting said electrical power through inductive coupling to a receiver coil of a receiver mounted on at least one mobile device, said at least one mobile device having a Bluetooth module, said at least one mobile device detachably placed on a head cover of said head assembly, a magnet for facilitating attachment of said at least one mobile device to said head cover, a Bluetooth module for transfer of said electronic data files;
wherein said head assembly is attachable to a plurality of said base assembly and said at least one electronic data file is transmitted from said at least one mobile device detachably placed on said head assembly through radio communication established between said Bluetooth module of said head assembly and Bluetooth module of said at least one mobile device to an external device.

18. A wireless charging device, the device comprising;
a housing having at least one input terminal for receiving electrical power, at least one transmitter coil for transmitting said electrical power through inductive coupling to a receiver coil of a receiver mounted on at least one mobile device, said at least one mobile device detachably placed to a head cover of said housing;
a magnet for facilitating attachment of said at least one mobile device to said head cover; and
at least one Near Field Communication tag in said head assembly for establishing radio communication with Near Field Communication enabled said at least one mobile device detachably placed to said head assembly;
wherein said housing is inserted into a surface and said head cover remains available over said surface for placing said at least one mobile device.

19. A wireless charging device as in claim 18, wherein said housing of wireless charging device is cylindrical in shape and mounted to a wall.

20. A wireless charging device as in claim 18, wherein said wireless charging device is cylindrical in shape and mounted to a piece of furniture.
